(19) United States
(12) Patent Application Publication
(10) Pub. No.: US 2009/0073804 A1
(43) Pub. Date: Mar. 19, 2009

(54) USING SOURCE ELEVATION MEASUREMENTS TO REMOVE SEA PERTURBATIONS

(76) Inventors: Robert Montgomery Laws, Cambridge (GB); Julian Edward Kragh, Finchingfield (GB)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(21) Appl. No.: 12/209,184

(22) Filed: Sep. 11, 2008

Related U.S. Application Data
(60) Provisional application No. 60/972,407, filed on Sep. 14, 2007.

(51) Int. Cl. G01V 1/38; G01V 1/28

(52) U.S. Cl. 367/21

(57) ABSTRACT

A method for correcting marine seismic data is described in which a measured surface elevation relative to a reference surface of an array of source units is used to compensate for variations in the height and/or shape of a sea surface. Various embodiments correct for the elevation of the array as a whole, differences in the elevation of source units within the array, and scattering from the sea surface which arises due to the sea surface not being flat.

### CROSS-REFERENCE TO RELATED APPLICATIONS

A claim of priority is made to U.S. Provisional Patent Application 60/972,407, filed Sep. 14, 2007, which is incorporated by reference.

### FIELD OF THE INVENTION

The present invention relates to methods and apparatuses for correcting for variations in the height and/or shape of a sea surface in the acquisition or processing of seismic data.

### BACKGROUND

The present invention relates to methods and apparatuses for correcting for variations in the height and/or shape of a sea surface in the acquisition or processing of seismic data.

In marine seismology, sources, such as air-guns or the like are used that send out shots/seismic signals into a sea and the formations beneath the sea, and receivers receive signals reflected back from the formations that may be analyzed to determine characteristics of the sub-sea formations. Typically, one or more streamer cables, each having a plurality of spaced apart receivers is deployed into the water behind a vessel, and one or more sources may be towed by the same or different vessel. Less than perfect knowledge of the actual positions of the source at the time of firing may result in less than acceptable seismic data.

Typically, each “source” is actually a source array comprising a plurality of source units, typically airguns, which fire simultaneously. A source array may, for example, comprise three rows of six airguns arranged in a grid formation and the source array may cover an area of 200 square meters or more. For most data processing the source array is treated as a single source, with a source signature resulting from a combination of the pulses produced by each of the airguns.

Conventionally in marine seismology, the source units are suspended from floats located at the sea-surface. All of the source units in an array are suspended from the same float. When carrying out marine seismic imaging of the subsurface strata one needs to establish the position and depth of the source array. The source units in the array are suspended from a float by chains of a known length, and conventionally the depth has been taken as the length of the chain. This means that the depth has been referenced to the sea surface, which has the disadvantage that the actual surface varies up and down with time due to tidal and wave effects and it is thus at a different distance from the seabed at the different times of the seismic experiments. The non-flatness of the sea-surface may also act to perturb the signal(s) radiated by the source arrays and may reduce the accuracy of the obtained seismic measurements. For example, the perturbation caused by the non-flat sea-surface may affect the scattering of the reflected signal.

The Global Positioning System (GPS), administered by the United States, is a satellite-based positioning system useful in marine seismic exploration, and seismic surveys may employ multiple GPS receivers at strategic points in a spread to determine the surface position of a vessel, or floats tethered to streamers and sources. However, this still does not provide knowledge of the actual position of the receivers on the streamers and the sources, as they are not at the surface. Thus, while GPS has been used for surface positioning in marine seismic data acquisition, its use for accurately determining actual vertical position of sources and receivers is not known.

Previously, as described in U.S. Patent Application No. 20060209634, the entire disclosure of which is hereby incorporated by reference for all purposes, methods for position determination using Global Positioning have been used to provide for correctly determining a vertical (and a horizontal) location(s) of a source(s) in a moving sea.

### SUMMARY

The present invention provides a method for correcting marine seismic data, the method comprising using a measured surface elevation relative to a reference surface of an array of source units to compensate for variations in the height and/or shape of a sea surface.

Surface elevation measurements may be made by measuring the elevation of a float from which individual source units are suspended to form the source array. Some embodiments of the invention use a shape of the sea surface which may be derived from elevation measurements of the float of the source array. Other embodiments may use elevation of the source units which may be calculated using elevation measurements of the float of the source array and the geometry of the array.

In a first embodiment, a correction is applied as an overall time shift to the received data to compensate for the elevation of the source array at the time of generating the source signal. This embodiment allows the adjustment of all the received data so that the source elevation of the entire array at the time each source signal is generated is the same. The elevation of the source array may be measured at the centre of the array or calculated at the centre of the array from measurements elsewhere on the array.

A second embodiment of the invention comprises using the elevations of a plurality of source units in the source array to adjust the firing times of the source units to compensate for the difference in elevation of the source units.

This embodiment corrects for differences in elevation between source units in the array.

Elevation measurements prior to a firing time may be used to predict the elevations of the source units at the firing time. Preferably, the firing times of the source units are adjusted to synchronise the down-going pulses from the source units.

A third embodiment of the invention comprises using a measured sea surface shape to correct received data for vertical displacement of source units by applying a convolutional filter applied to the received data.

The third embodiment also corrects for differences in elevation between source units in the array.

A fourth embodiment of the invention comprises using a measured sea surface shape at a time a source signal is generated to calculate a scattering response of a sea surface and deconvolving the calculated scattering response from received data.

This embodiment corrects for the scattering of the sea surface which arises due to the sea surface not being flat.

Preferably, the calculated scattering response is deconvolved from the received data by filtering.

### BRIEF DESCRIPTION OF THE DRAWINGS

Embodiments of the present invention will now be described with reference to the accompanying drawings in which:

FIG. 1 is a schematic illustration of one embodiment of the invention;

FIG. 2 is a schematic side elevation view of a source float in accordance with the invention;

FIG. 3A illustrates the effect of correcting the amplitude errors caused by scattering from the sea surface on the source wavelet; and

FIG. 3B illustrates the effect of correcting the phase errors caused by scattering from the sea surface on the source wavelet.

### DESCRIPTION

Embodiments of the present invention provide for the correction of sea-surface perturbations from marine seismic signals. In certain aspects, sea-surface elevation measurements may be made using a GPS antenna or the like. The GPS antenna may comprise the GPS antenna described in U.S. Patent Application No. 20060209634. In one embodiment of the present invention, the measurements may be made at a frequency that follows the vertical motion of the floats on the waves and tide.

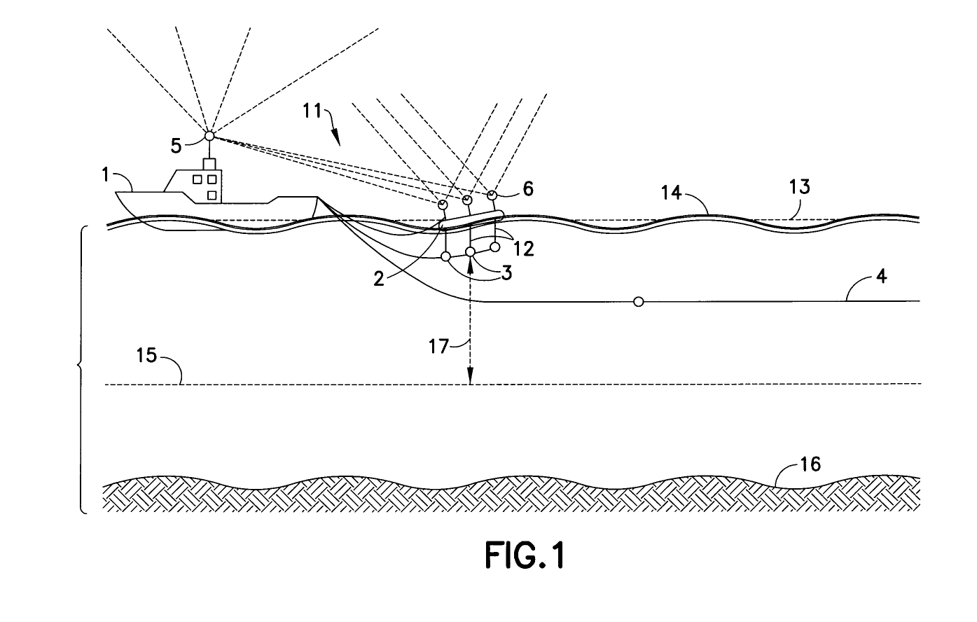

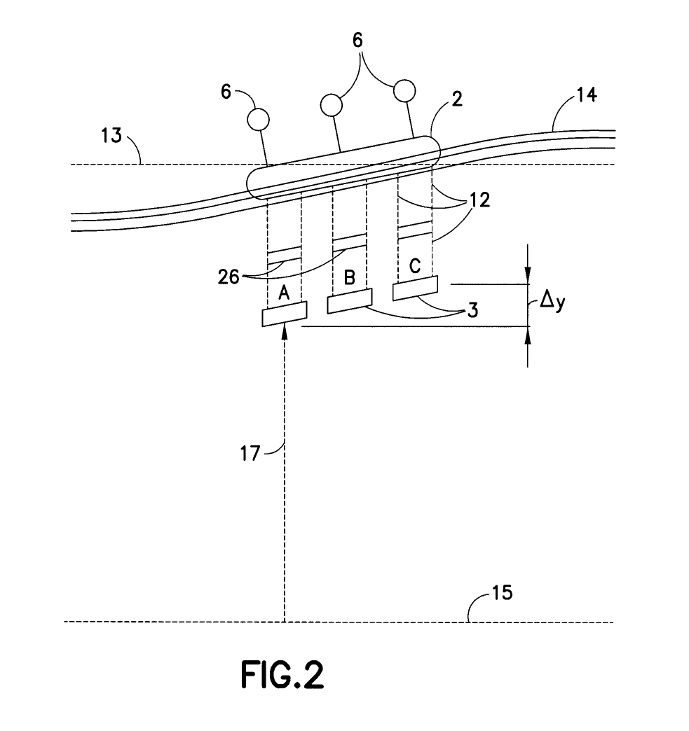

Referring now to the figures, FIG. 1 illustrates schematically and not to scale a system and method of the invention, including a vessel 1, a source float 2 having source units comprising air-guns 3 suspended from float 2 by chains 12 to make up a source array, as can be more easily seen in FIG. 2, and a streamer cable 4. Those of skill in the art will realize many variations, and this is but one way of obtaining marine seismic data. Vessel 1 includes an antenna 5 connected to a receiver (not shown). Antenna 5 may be positioned on a mast or other extension of the vessel 1, which may reduce the antenna's exposure to waves, water spray, wakes, and the like. Three antennas 6 are depicted on source float 2. The average sea level is indicated by a dotted line 13, and the actual sea level at 14. A mathematically derived surface is indicated at 15, and the seabed is indicated at 16. Derived surface 15 is a reference surface and could be above or below the sea surface 14. As illustrated, a dotted line 17 indicates height or depth of source units 3 above mathematical surface 15.

Lines coming from above antennas 5 and 6 indicate transmitted signals from a positioning system, such as the Global Positioning System satellites, which are used to determine the absolute vertical positions of the antennas 6 in accordance with the method disclosed in US2006/0209634. Other satellite positioning systems may be used, and may be selected from any functioning system, or future functioning system, or alliance of systems, including, but not limited to the Global Positioning System operated by the United States; the European Union's system known as GALILEO; Russia's system known as GLONASS; Japan's system known as the QUASI-ZENITH SATELLITE SYSTEM, and China's system known as TWINSTAR.

Completing FIG. 1 is a calculated spatial vector 11 (three spatial vectors 11 are depicted, depending on which antenna 6 is chosen), calculated by combining and processing signals received by antennas 5 and one of antennas 6, as further explained in US2006/0209634. Knowing the 3D coordinate position of antenna 5 and spatial vectors 11 allows the 3D coordinate positions of antennas 6 to be determined. FIG. 2 illustrates more clearly three antennas 6 attached to float 2, and source units 3 attached via chains 12 and plates 26 to float 2. Since the height of the antennas 6 from the float 2 and the length of chains 12 is known, the vertical position of air-guns 3 or other acoustic source units can be calculated, at least in reference to mathematical surface 15, as indicated by dotted line 17.

Of course, the number of antennas 6 is not critical if the geometry of the source array is known, and the minimum number of antennas 6 required will depend on whether only the vertical elevation of the whole array is required, or whether its orientation with respect to the horizontal is also required. For example, if it is only required to know the vertical position of the whole source array, one antenna 6 may be sufficient to calculate the 3D coordinate positions of the array. If it is desired to measure the inclination of the source float 2 in one direction, two antennas may be provided, or three or more antennas may be provided to determine the inclination of the source float in three dimensions. If all physical dimensions of a source array are known, then the positions of all of the source units 3 can be calculated. It is only out of convenience that FIG. 1 depicts one antenna 6 per source unit (air-gun) 3.

As the sea surface elevation changes, the source units 3 in the array move up and down following the sea shape above them. In an embodiment of the present invention, the sea surface elevation and/or the vertical location of the float 2 may be measured and the positions of the source units 3 may be inferred/determined in order that effects caused by the movements of the source units 3 cause may be corrected. There are three types of effect and four types of correction that can be applied.

The largest perturbation effect is due to the fact that the whole source array moves up and down. This motion of the source array causes a time shift in the received data, which, in accordance with a first embodiment of the present invention is corrected by determining the elevation of the array (for example, the elevation at the centre of the array) at the time the shot is fired and applying the appropriate time shift to the received data. This perturbation includes not only the sea movement but also tidal effects as long as the surface elevation is measured relative to the survey datum. By way of example, this perturbation may represent an error that is about 21 dB below the signal in a 4 meter significant-wave-height (“SWH”) sea.

Smaller than the largest perturbation described above, is a perturbation resulting from an intra-array effect, whereby the vertical movement of source units 3 relative to each other is significant, i.e. the float 2 is inclined to the horizontal, both in the inline direction and the cross line direction. This motion within the array may affect the pulse shape, since the down-going pulses from the source units 3 are no longer synchronized perfectly, and may be out of phase with each other and the ghost pulses (reflected from the sea surface) are also perturbed. By way of example, such a perturbation may represent an error that is about 28 dB below the signal in a 4 meter SWH sea.

There are two possible means of correcting for this effect and these can be used in conjunction. In a second embodiment, the differences in elevation of the source units 3 may be compensated by adjusting the timing of the firing of the source units 3 to account for the inclination of the source array and therefore the height difference between the source units 3. This means that the down-going pulses are coherent despite the source units 3 being at perturbed elevations. The adjustment of the synchronization may be made in response to determinations of the relative positions of the source units 3 prior to firing the source units 3 in the array. The elevations at the time the shot is fired may be predicted using a time evolution from measured elevations in a time period leading up to the shot. For example, such an aspect may be provided by the measurement of the elevations of the source units 3 over a time of about 10 seconds leading up to the firing of a shot and at a sample interval of about 1 Hz or better.

For example, in the source array shown in FIG. 2, there is a difference Δy between the elevations of source units A and C at the time of firing the shot, which can be corrected by changing the firing times so that source unit C fires before source unit A by time difference Δt=Δy/c where c is the velocity of the seismic wave. The difference Δy is predicted by predicting the elevations of source units A and C by a time evolution or extrapolation from the measured elevations of source units A and C in a time period prior to firing the shot. For example, the elevations of the source units A and C may be measured over a time of about 10 seconds leading up to the firing of the shot at a sample interval of about 1 Hz or better to extrapolate the elevations of source units A and C at the time of firing the shot, and thus the predicted elevation difference Δy.

In a third embodiment of the present invention, the perturbation due to relative motion of the source units 3 may be corrected by the pulse shape of the whole source array being left perturbed and the received data being corrected by a wavelet shaping filter, which has been derived from the elevation measurements. A wavelet shaping correction may be beneficially used in addition to the adjustment of the firing times as described above. This is because, although the adjustment of the firing times makes the down-going pulses coherent, it will not necessarily do so for the ghost pulses. The ghost pulses are those reflected from the sea surface, which then combine with the down-going pulses.

Finally, in a fourth embodiment, a smaller perturbation to the seismic data acquired in a marine seismic operation may be caused by the fact that the sea surface is not flat and, as a result, the ghost reflections, which travel downwards and combine with the source signature, is not a simple response but may include some scattering. By way of example, this smaller perturbation may represent an error that is about 34 dB below the signal in a 4 meter SWH sea.

In an embodiment of the present invention, the smaller perturbation may be corrected by estimating the sea surface shape from the elevation measurements of the array and using a Kirchhoff calculation or the like to compute a scattering response and correct the received signal for the scattering effects. In certain aspects of the present invention, the correction would be applied as a wavelet filter applied to the received data.

More specifically, this aspect of the invention aims to deconvolve the effect of the scattering. The effect is different for every shot because the shape of the sea is different for each shot. If the exact shape of the surface at the moment the source array fires were known, it would be possible to calculate the particular effect it has on the down-going pulse shape by using standard Kirchhoff integration. In this case, it is important to include the Kirchhoff ‘near field’ term which is normally not needed in seismic applications. It is needed in this case because the source array is so close to the scattering surface. The surface preferably needs to be known out to a distance of about 200 m from the source to accurately correct for the scattering effect. However, any error in the method of the present invention arises from not knowing the shape of the sea surface accurately.

The present inventors have found that the shape of the surface can be estimated by using the several height measurements that are made within the source array. However, these do not cover the whole area we are interested in for optimum accuracy (out to 200 m). The present inventors have further found that the shape of the sea surface can be modeled by further knowing that the sea surface waves obey a well defined dispersion relation. This allows the shape at large distances where there are no height measurements to be related to the height measurements near the array at earlier and later times compared with the shot time. The surface shape is estimated using the measurements made over many seconds centred on the shot time. The measurements made at early and late times provide the information to estimate the surface at the shot time at larger distances.

Merely by way of example, such an aspect may be provided by the measurement of the elevations of the source units over a time of about 10 seconds leading up to the firing of a shot and at a sample interval of about 1 Hz or better. A correction for the scattering response of the sea surface may be applied to seismic data by using a calculated scattering function based on the measured sea shape at the time the shot was fired.

This method of estimating the surface shape at distances where there are no height sensors is not completely accurate. In particular there is an ambiguity about the angular distribution of the surface shape. This ambiguity is worse if the array is smaller. However, the present inventors have found that the error is less significant than might be expected because the calculation of the vertical far field scattering (Kirchoff is rather insensitive to the error.

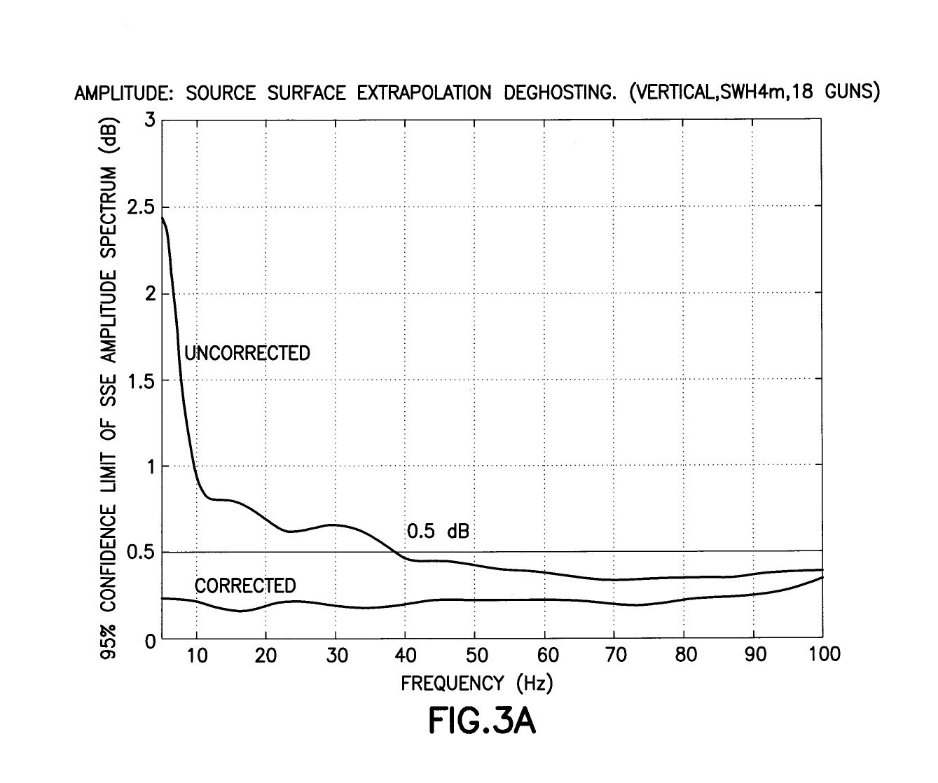

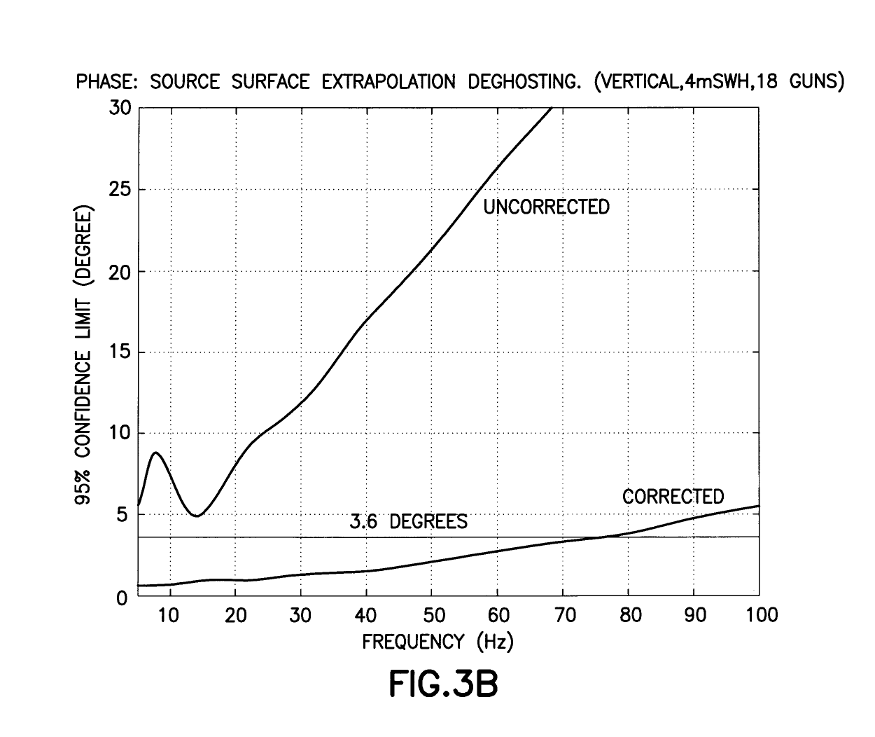

FIGS. 3A and 3B, below, illustrate the effect of correcting the amplitude and phase errors, respectively, caused by the sea surface on the source wavelet. In FIGS. 3A and 3B, the amplitude and phase perturbations may be caused by rough sea surfaces of the order of 4 meters significant wave height. The uncorrected curves (top) show the size of the perturbations if left uncorrected. The corrected curves (bottom) show the residual error after correction using the surface elevation measurements.

A typical use of this invention will be in 4-D geophysical imaging, where a 3-D seismic survey is repeated over a grid that has been previously surveyed. This series of surveys taken at different times may show changes to the geophysical image over time caused, for example, by extraction of oil and gas from a deposit. When acquiring seismic data over weeks and months as is typical for a seismic 3D survey it is important that the whole data set can be referenced to the same level with a precision and certainty. 4D seismic requires data sets acquired at intervals over years to be compared looking for the subtle changes in the subsurface as an oilfield gets produced. Using the methods, apparatus, and systems of the invention, the height or depth of the seismic sources and receivers may be determined with respect to a reference that can be reconstructed with a high degree of precision at any future or past time epoch. This is in contrast to the sea surface referenced data that can only be approximated at a different time given that accurate environmental information is available. It is important that the source members being used to generate the acoustical pulses be located as closely as possible to the same location as in previous surveys over the same grid. This has been difficult to accomplish in a marine survey because the acoustical source members are typically towed behind the tow vessel in source arrays, which are subject to wave and current movement. The present invention makes it possible to monitor the difference and apply a correction for it.

While the principles of the disclosure have been described above in connection with specific apparatuses and methods, it is to be clearly understood that this description is made only by way of example and not as limitation on the scope of the invention. Further, a number of variations and modifications of the disclosed embodiments may also be used.

What is claimed is:

1. A method for correcting marine seismic data, the method comprising using a measured surface elevation relative to a reference surface of an array of source units to compensate for variations in the height and/or shape of a sea surface.

2. The method of claim 1, comprising using the elevations of a plurality of source units in the source array to adjust the firing times of the source units to compensate for the difference in elevation of the source units.

3. The method of claim 2, comprising using elevation measurements prior to a firing time to predict the elevations of the source units at the firing time.

4. The method of claim 2, wherein the firing times of the source units are adjusted to synchronise the down-going pulses from the source units.

5. The method of claim 1, comprising using a measured sea surface shape to correct received data for vertical displacement of source units by applying a convolutional filter applied to the received data.

6. The method of claim 1, comprising using a measured sea surface shape at a time a source signal is generated to calculate a scattering response of a sea surface and deconvolving the calculated scattering response from received data.

7. The method of claim 6, wherein the calculated scattering response is deconvolved from the received data by filtering.

8. The method of claim 1, wherein a correction is applied as an overall time shift to the received data to compensate for the elevation of the source array at the time of generating a source signal.

9. The method of claim 1, wherein a shape of the sea surface is derived from elevation measurements of a float of the source array.

10. The method of claim 1, wherein elevations of the source units are calculated using elevation measurements of a float of the source array and the geometry of the array.

11. A computer readable medium having a computer program stored thereon, wherein the computer program comprises computer readable instructions for carrying out the method of claim 1.
